(19) United States
(12) Patent Application Publication
(10) Pub. No.: US 2023/0038307 A1
(43) Pub. Date: Feb. 9, 2023

(54) NETWORK INTERFACE DEVICE FEEDBACK FOR ADAPTIVE AND FAILOVER MULTIPATH ROUTING

(71) Applicant: Intel Corporation, Santa Clara, CA (US)

(72) Inventors: Jeremias BLENDIN, Santa Cruz, CA (US); Junggun LEE, Los Altos, CA (US); Yanfang LE, San Jose, CA (US)

(21) Appl. No.: 17/879,410

(22) Filed: Aug. 2, 2022

Related U.S. Application Data
(60) Provisional application No. 63/328,030, filed on Apr. 6, 2022.

(51) Int. Cl. H04L 45/00; H04L 45/28; H04L 47/125

(52) U.S. Cl. CPC H04L 45/38; H04L 45/28; H04L 47/125

(57) ABSTRACT

Examples described herein relate to a network interface device comprising: circuitry, when operational, to: in response to congestion related to a link, cause transmission of link event information to at least one sender of packets to the link, wherein the link event information is to identify congestion information of at least one link other than the link.

### RELATED APPLICATION

This application claims priority to U.S. Provisional Application No. 63/328,030, filed Apr. 6, 2022. The entire contents of that application are incorporated by reference in its entirety.

### BACKGROUND

Multi-path communication is utilized in networking to provide multiple options for network traffic to reach a destination from a sender. One approach to end-to-end multipath communication establishes multiple flows between two communication endpoints that leverage hop-by-hop and/or flow-based load-balancing (or other schemes) to ensure the flows use different and potentially non-overlapping paths of one or more links through the network to the destination. A sender device sends data through a first flow, while the second flow is kept active in case a link on the path of the first flow fails or is overloaded.

Some Clos architectures utilize hop-by-hop flow-based load-balancing. Schemes such as equal-cost multipath (ECMP), or other schemes, can be utilized whereby, as an example using ECMP, hashing of selected packet header fields (e.g., 5-tuple-based for IPv4 or flow label for IPv6) can be used to distribute traffic load over multiple links to attempt to provide that packets of a same flow take a same path and attempt to provide in-order delivery of packets in flows.

### BRIEF DESCRIPTION OF THE DRAWINGS

FIG. 1 depicts an example system.

FIG. 2 depicts an example system.

FIGS. 3A and 3B provide examples triggers at congested node.

FIGS. 4A and 4B depict example processes.

FIG. 5 depicts an example network interface device.

FIG. 6 depicts an example switch.

FIG. 7 depicts an example system.

FIG. 8 depicts an example system.

### DETAILED DESCRIPTION

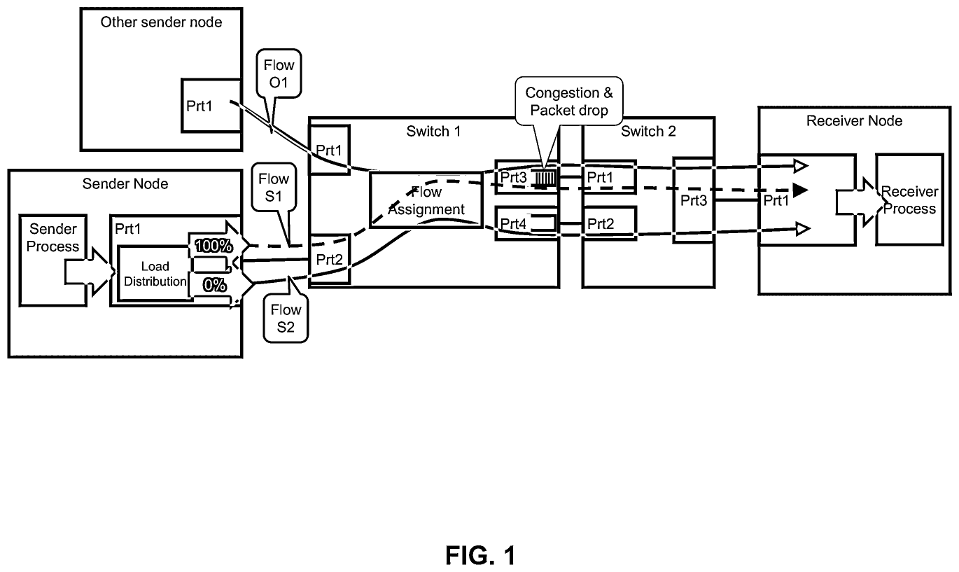

FIG. 1 shows an example of a sender process utilizing multiple parallel network paths through a network. For example, flow S1 can utilize a primary path and flow S2 can utilize a backup or redundant path. Where there are multiple paths from sender to receiver, multiple links can be available through Switch 1 and Switch 2. The sender process sends a traffic flow on one or more of these paths. If an issue on one of the used paths occurs, such as congestion, a different path can be chosen from a pre-established set of paths so that packet traffic is either sent on a single path or sent among multiple paths. Multiple links can be provided by port3 (Prt3) of Switch 1 connected to port1 (Prt1) of Switch 2 and port4 (Prt4) of Switch 1 connected to port2 (Prt2) of Switch 2. Switch 1 and switch 2 can be connected through two parallel links over which the traffic can be distributed.

One way to assign flows to links is flow hashing whereby hash values of a set of fields of the packet header (e.g., the 5-tuple for IPv4) can be used to assign the flow to a link. Assignment is consistent for a given 5-tuple and can enforce in-order delivery of packets of a flow, while being stateless.

In this example, other sender node sends packets associated with Flow O1 through Switch 1's Prt3 to Switch 2's Prt1 to Receiver Node. Flow O1 uses the same link as that of Flow S1. Port Prt 3 can receive packets from one or more queues associated with different traffic classes. Both flows O1 and S1 together have a higher arrival rate than the Prt3's link capacity and the depth of the queue on this port grows. At Switch 1, application of scalable reliable datagram (SRD) (e.g., L. Shalev, H. Ayoub, N. Bshara, and E. Sabbag, “A Cloud-Optimized Transport Protocol for Elastic and Scalable HPC,” in IEEE Micro, vol. 40, no. 6, pp. 67-73, 1 November-December 2020) can detect this queue build-up after feedback from the Receiver Node. However, at this point in time, the queue buildup can be significant and could have led to packet drop(s) for Prt 3 on Switch 1. Using SRD or other mechanism, flows S1 and S2 can be mapped to two different links from Switch 1 to Switch 2. Sender Node can transfer the Sender Process' traffic load over Flow S1 and flow S2 can be kept and maintained as a backup in case the primary flow's path through the network fails or is congested. A path can include one or more links between ports of devices.

Switch 1 moving one of the two flows to a different link can cause packets to be enqueued in a congested queue and later packets to be enqueue in an uncongested queue. Thereby, later packets could overtake earlier packets of the same flow, potentially breaking in-order delivery of packets.

Some transport layer protocols (e.g., SRD, Transmission Control Protocol (TCP), Remote Direct Memory Access (RDMA) over Converged Ethernet (RoCEv2), etc.) provide in-band end-to-end congestion control mechanisms to react to congestion in the network whereby a receiver node indicates congestion at an intermediate node to a sender node. By design, these protocols react over a timespan of multiple end-to-end round-trip times (RTTs). While this is sufficient for many situations, in case of high-performance RDMA networking, significant queue build-up and potentially packet loss can occur.

At least to reduce a time for a sender to identify and potentially reduce an impact of congestion on packet transmission, technologies described herein provide back-to-sender (BTS) signals to transmit network telemetry from forwarding devices (e.g., switch, router) in the network to indicate information on a congested link and at least one other parallel link. In some examples, as described herein, BTS signals can include telemetry information concerning a currently used queue, port, and/or link and also telemetry information concerning at least one other parallel or multi-path queue, port, or link. BTS signals can include information about congestion events at the switch where the event occurred and be provided by a packet processing fast-path such as a programmable packet processing pipeline of the switch, as described herein. A sender can reduce impact of congestion on packet transmission by pause/resume flow control, path control or change, congestion control, and so forth adaptive to the type and location of the signaled event, as described herein. A sender reaction policy can change currently used path based on failure or congestion at a parallel link, or others. The BTS signals can lower reaction delay to events occurring in the network and feedback delay can be less than 1 RTT.

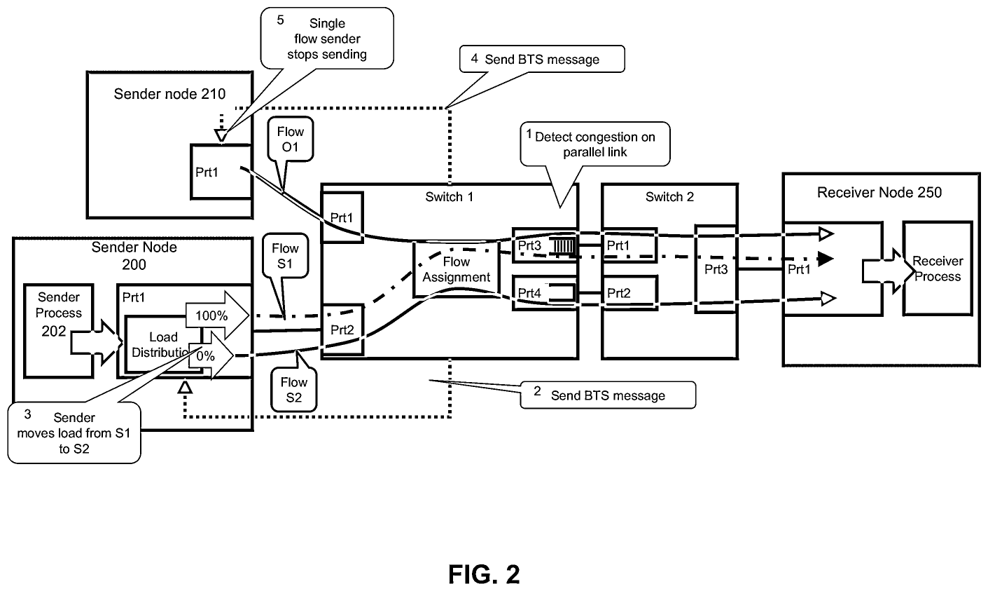

FIG. 2 depicts a system and operation. Sender Node 200 sets up two flows S1 and S2 to send traffic to Receiver Node. Sender Node 200 can select one or more paths for transmitted packets in-network hop-by-hop using a variety of techniques such as n-tuple hashing (where n is an integer), or explicitly establishing tunnels (e.g., Multiprotocol Label Switching (MPLS) Label Distribution Protocol (LDP), Segment Routing over IPv6 dataplane (SRv6) source routing, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth. In Switch 1, the flows can be assigned to Port3 (Prt3) and Port4 (Prt4).

In some examples, Sender Node 200 transmits a packet load for sender process 202 using Flow S1 and maintains Flow S2 as a backup path. A flow can include a sequence of packets transferred between two endpoints, generally representing a single session using a known protocol. Accordingly, a flow can be identified by a set of defined tuples and, for purposes of routing or directing a flow through links, a flow is identified by the two tuples that identify the endpoints, e.g., the source and destination addresses. In other examples, for purposes of routing or directing a flow through links, a flow can be identified by n-tuples. For content-based services (e.g., load balancer, firewall, intrusion detection system, etc.), flows can be differentiated at a finer granularity by using n-tuples (e.g., source address, destination address, IP protocol, transport layer source port, and destination port, or other protocol specific information, such as destination queue pair (QP) identifiers (IDs) for RoCEv2). A packet in a flow is expected to have the same set of tuples in the packet header. At least for ECMP, SRD, or others, a packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

For VLAN-based mechanisms, the VLAN could establish a path and identify a flow. For Multi-protocol label switching (MPLS), a label-switched path can be established and identify a flow, for source-routing-based mechanisms, such as segment routing each packets can include one or more hops to pass to the destination. In the segment routing case, source routing can be combined with n-tuple hashing to identify a flow. An example of segment routing is described at least in Internet Engineering Task Force (IETF) Segment Routing Architecture Request for Comments (RFC) 8402 (2018).

A path can represent a sequence of nodes, switches, and links that packets of a flow traverse through a network. A parallel link can represent one link of multiple links that connect a pair forwarding node to one or more forwarding nodes in a network through which packets can reach the same receiver node. Packets of parallel links can traverse the same path or different paths to the receiver node. For example, packets of flow S1 can traverse same or different switches to Receiver Node 250 as switches used to forward packets of flow S2 to Receiver Node 250. End-to-end multipath communication can include two endpoints that establish multiple flows between them that are designed to take separate paths through the network.

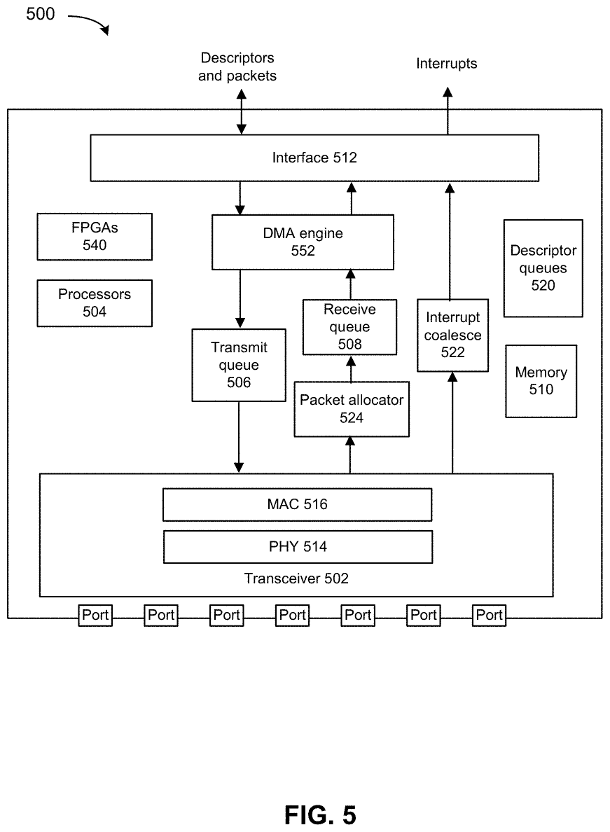

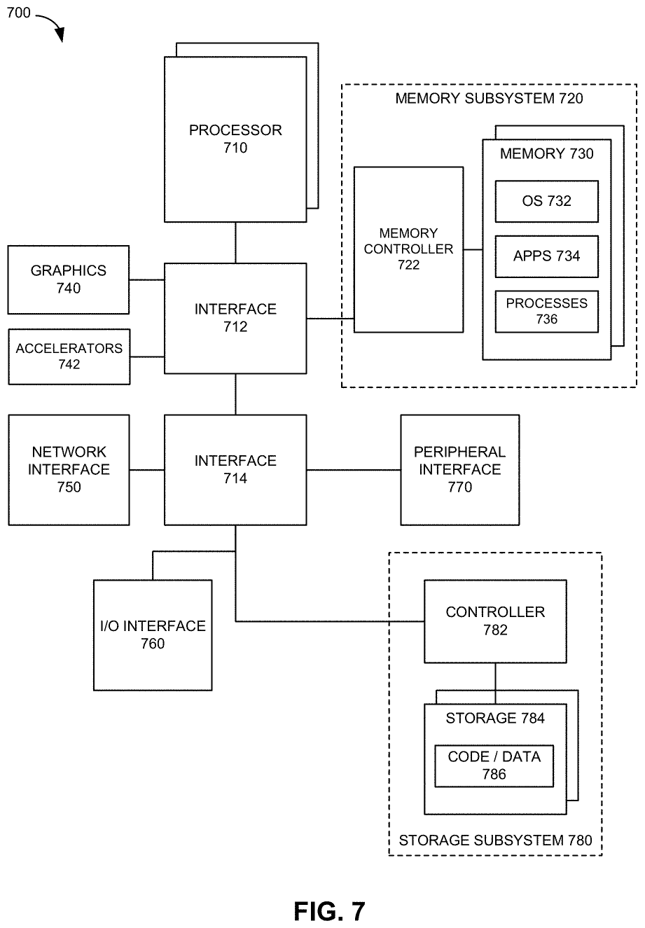

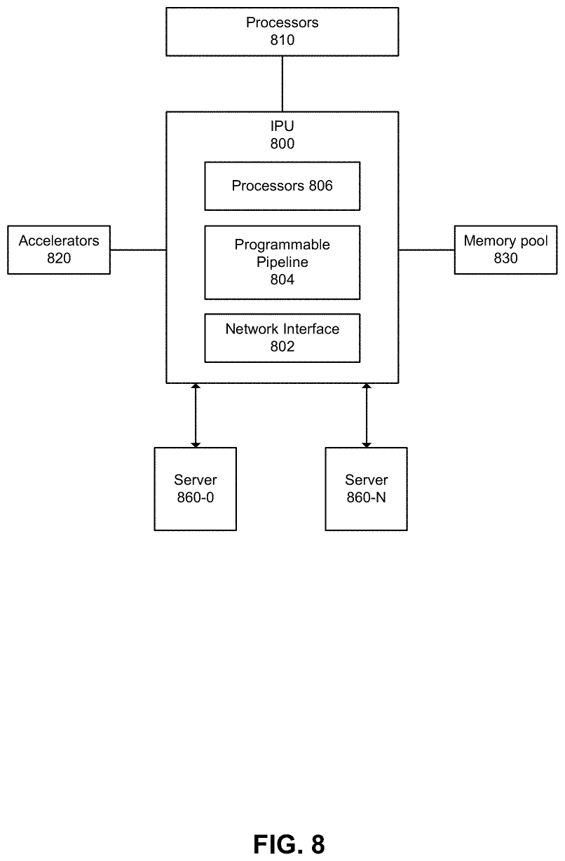

Sender Node 200 can include a host system and a network interface device. At least one example of host system is described at least with respect to FIG. 7 or 8. At least one example of a network interface device includes one or more of: a network interface controller (NIC), a remote direct memory access (RDMA)-enabled NIC, SmartNIC, router, switch, forwarding element, infrastructure processing unit (IPU), data processing unit (DPU), or network-attached appliance. At least one example of network interface device is described with respect to FIGS. 5, 6, 7, and/or 8. Similarly, Sender Node 210 can include a host system and network interface device. Similarly, Receiver Node 250 can include a host system and network interface device. At least one example of Switch 1 and Switch 2 is described with respect to FIGS. 5, 6, 7, and/or 8.

When sender node 210 transmits flow O1 to queue for Port3, or for other causes, queue for Port3 can start to build up and becomes congested, at (1), congestion can be detected on Switch 1. For example, congestion can arise from one or more of the following cases:
Case A: Transient link overload of link that is part of a group of parallel links
Case B: Link failure of link that is part of a group of parallel links
Case C: Link closing in on transmission capacity
Case D: Link in group of parallel links has spare capacity while another link in the group of parallel links is overloaded

In the example of FIG. 2, a set of pre-established paths can be used by Sender Node 200 to transmit packets to Receiver Node 250. However, other manners of setting a path from Sender Node 200 to Receiver Node 250 can occur, such as segment routing using source routing where Sender Node 200 can specify a link to use between switch 1 and switch 2. As a reaction to a congested path, Sender Node 200 could add a specifier to select a specific link between switch 1 and switch 2.

In response to a BTS indicating congestion, Sender Node 200 can utilize a backup flow S2 for flow S1. Sender Node 200 can select a link to send backup flow S2 based on BTS information received from switch. Sender Node 200 can utilize one or multiple different flows to transmit packets to a destination. For example, different flows can be identified by different tuples, different VLAN tags, segment routing design, or others. Sender node 200 can determine a path of packets of a flow to a destination or one or more intermediary nodes can decide next link of path to the destination.

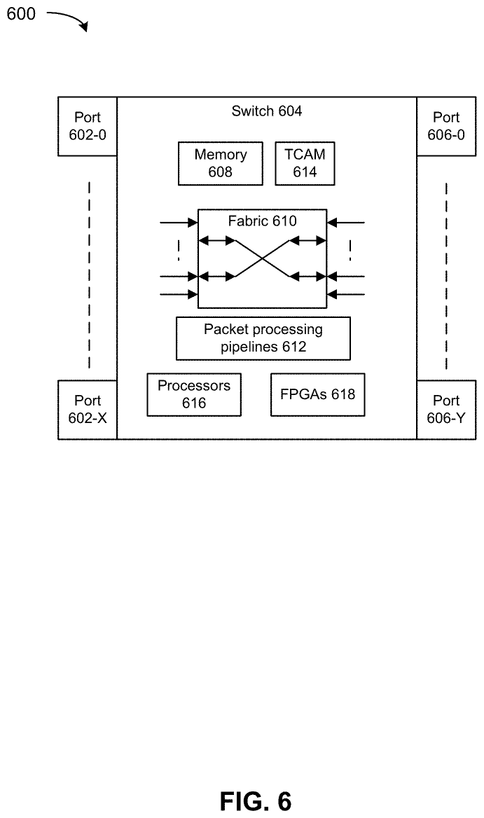

In some examples, a packet processing pipeline of switch such as described with respect to FIG. 6 can be used to detect cases A-D at (1) and cause transmission of at least one BTS message at (2) and (4). The content of BTS message sent by switch nodes can depend on a multipath mechanism used by Sender Node 200 as well as the specific network imbalance that causes the BTS response.

For case A, at (1), there is a detection of a congested queue that corresponds to a link in a group of multiple links from Switch 1 to Switch 2. In this example, the congested queue is for port 3. For example, a queue can be identified as congested based on a queue depth of the queue (e.g., number of bytes or number of packets) and a threshold level. Based on a determination that the congested queue corresponds to a link in a group of multiple links from Switch 1 to Switch 2, at (2), Switch 1 can utilize BTS to signal sender node 200 that flows S1 and S2 arriving in the queue of Port3 that congestion is occurring as well as information about at least one parallel link (e.g., existence of at least one parallel link, congestion information, or other information described herein). Various examples of information conveyed in a BTS are described herein.

For case B (e.g., link failure of link that is part of a group of parallel links), at (1), there is a detection of a link failure in a group of multiple links from Switch 1 to Switch 2. A link can include a physical connection between switches or a switch and a network interface device. Link failure can include inability of a link to transmit packets, transmission rate of packets or bits being at or below a threshold level, or error rate of transmitted packets meeting or exceeding a threshold level. Based on a determination that the failed link corresponds to a link in a group of multiple links from Switch 1 to Switch 2, at (2), Switch 1 can utilize BTS to signal sender node 200 that flows S1 and S2 arriving in the queue of Port3 that congestion is occurring and information about at least one other parallel link, as described herein. Various examples of information conveyed in a BTS are described herein.

For case C (e.g., link closing in on transmission capacity), at (1), there is a detection of link, in a group of multiple links from Switch 1 to Switch 2, closing or arriving at transmission capacity. Transmission capacity can be set at a threshold bandwidth such as a threshold level of packets per second or bits per second that is less than or at a peak throughput rate for a link. Based on a determination that the link is closing in on transmission capacity corresponds to a link in a group of multiple links from Switch 1 to Switch 2, at (2), Switch 1 can utilize BTS to signal sender node 200 that flows S1 and S2 arriving in the queue of Port3 that congestion is occurring and information about at least one other parallel link, as described herein. Various examples of information conveyed in a BTS are described herein.

For case D (e.g., link in group of parallel links has spare capacity while another link in the group of parallel links is overloaded), at (1), there is a detection that a link in a group of parallel links has spare capacity while another link is overloaded in a group of multiple links from Switch 1 to Switch 2. A link can be overloaded where a transmission rate through the link is less than or at a throughput rate for a link identified as overloaded. Spare capacity on another link can be identified based on the other link being capable of providing a transmission rate at or above a throughput rate (e.g., packets per second or bits per second). Based on determination that the link in group of parallel links has spare capacity while another link that is overloaded corresponds to a link in a group of multiple links from Switch 1 to Switch 2, at (2), Switch 1 can utilize BTS to signal sender node 200 that flows S1 and S2 arriving in the queue of Port3 that congestion is occurring. Various examples of information conveyed in a BTS are described herein.

Depending on a case (e.g., case A, B, C, or D) and information conveyed in a BTS, operation (3) can include a reaction performed by Sender Node 200 to receipt of the BTS. The BTS message can arrive at Sender Node 200 earlier than provided by transport-protocol-based in-band mechanisms such as latency measurements (used by SRD for example) because switch sends BTS to Sender Node 200 instead of to Receiver Node 250 for forwarding to Sender Node 200. In some examples, Sender Node 200 can shift load from Flow S1 to Flow S2 and assign traffic to Flow S2 until the congestion condition is resolved. However, other example reactions by sender node are described herein.

At (3), based on a received BTS message, Sender Node 200 network interface device can include circuitry to determine to change a path or utilize multiple paths. In some examples, based on a received BTS message, in addition, or alternatively, an operating system (OS) executed by a host system of Sender Node 200 can determine to change a path or utilize multiple paths. For example, adjusting transmission of packets can include Sender Node 200 causing Switch 1 to use one or more other links (e.g., at least port 4 (Prt4)), instead of Prt3, to transmit packets from Sender Node 200 via Switch 2 to Receiver Node 250. For example, adjusting transmission of packets can include the Sender Node 200 causing Switch 1 using the congested link and one or more other links (e.g., at least port 4 (Prt4)) to transmit packets from Sender Node 200 via Switch 2 to Receiver Node 250.

Sender Node 200 can cause Switch 1 to use Prt 3 and Prt 4 or another port or merely Prt 4 or another port by various technologies. For example, when SRD is used with ECMP and n-tuple flow hashing, Sender Node 200 can choose to send traffic from sender process 202 using Flow S2 (FIG. 2). In case a multipath approach with no pre-established alternative flows is used, Sender Node 200 can modify a field of the known n-tuple used to calculate the per-flow hash on Switch 1. In some examples, the field includes a field that stores the source port number. A change can cause the flow to choose a different path through the network because of the change in outcome of the n-tuple hash calculation. In some cases, this new path will not include the congested link. If the new path still includes the congested link, Sender Node 200 can choose a different n-tuple field modification. If the BTS message includes information of the hash values to avoid and the hash-values to prefer, Sender Node 200 can try multiple values for the modification of the field of the n-tuples until the preferred hash value output is achieved.

In a case that a source-routing approach such as Segment Routing is used and the BTS message includes information on the Segment Routing adjacency of Switch 1 to avoid, instead of using the Receiver Node 250 as destination in the segment stack (e.g., segment stack: [Node: 250]), Sender Node 200 can specify the new link to use in a segment stack (e.g., segment stack: [Node: Switch 1, Adjacency: Port 4, Node: 250]. In case a VLAN or label-switched approach is used, Sender Node 200 can either leverage topology information from the path-establishment to select a path that does not include the congested link or just a random path which may or may not include the congested link.

At (4), Switch 1 can send a BTS message to at least one other sender node 210. The BTS message can be a copy of BTS message that sent in (2) or can be different. At (5), the at least one sender node 210 can perform a reaction to the BTS message. Example reactions by other sender nodes 210 are described herein.

In (2) and (4), for a node or parallel link group, information in a BTS sent by Switch 1 can be supplemented by forwarding elements with forward status for nodes/parallel links on BTS path. For example, the BTS packet can include multipath status (e.g., bifurcations, nodes involved) of the forward path while traveling backwards to sender node 200 to allow sender node 200 to perform a reaction to decide which bifurcation in the multipath communication to avoid specifically. For example, in (2) and (4), examples of data to transmit is listed in the information column below.

| | End-to-end | In-network | | |
|---|---|---|---|---|
| | protocol | multipath | | Implementation |
| Information | examples | mechanism | Data | example |
| Flow ID | Multiple | Multiple | First 64 bytes of the | Copy original packet, |
| | | | packet that triggered | truncate, and prepend |
| | | | the BTS | BTS header |
| Flow ID | SRD | ECMP | 5-tuple + in data center | Copy field values from |
| | | | transport tunnel | packet that triggered |
| | | | encapsulation if any | transmission of BTS |
| | | | | message |
| Flow ID | SRv6, SR- | SR source | 5-tuple + in data center | Copy field values from |
| | MPLS | routing | transport tunnel | packet that triggered |
| | | | encapsulation if any, | transmission of BTS |
| | | | next SR segment value | message |
| Flow ID | SPAIN | VLAN | VLAN tag + 5 tuple | Copy field values and |
| | approach | assignment | | VLAN tag from |
| | | | | packet that triggered |
| | | | | transmission of BTS |
| | | | | message |
| Node and | SRD | ECMP | Provide hash input | On network setup, |
| Link ID | | | header fields, their | collect all hash input |
| | | | values from the packet | value and hash |
| | | | that triggered BTS, | computation algorithm |
| | | | hash computation | combinations in the |
| | | | algorithm, and hash | network. Share them |
| | | | output values that are | as lists to all involved |
| | | | affected | nodes (e.g., though |
| | | | | LLDP). BTS message |
| | | | | can reference an entry |
| | | | | in this list and the |
| | | | | output values to avoid. |
| Node and | SRv6, SR- | SR source | Node label of node, | Use values provided |
| Link ID | MPLS | routing | adjacency label of link | by SR control plane |
| Node and | SPAIN | VLAN | VLAN tag + 5 tuple | Copy field values and |
| Link ID | approach | assignment | | VLAN tag from |
| | | | | packet that triggered |
| | | | | transmission of BTS |
| | | | | message |

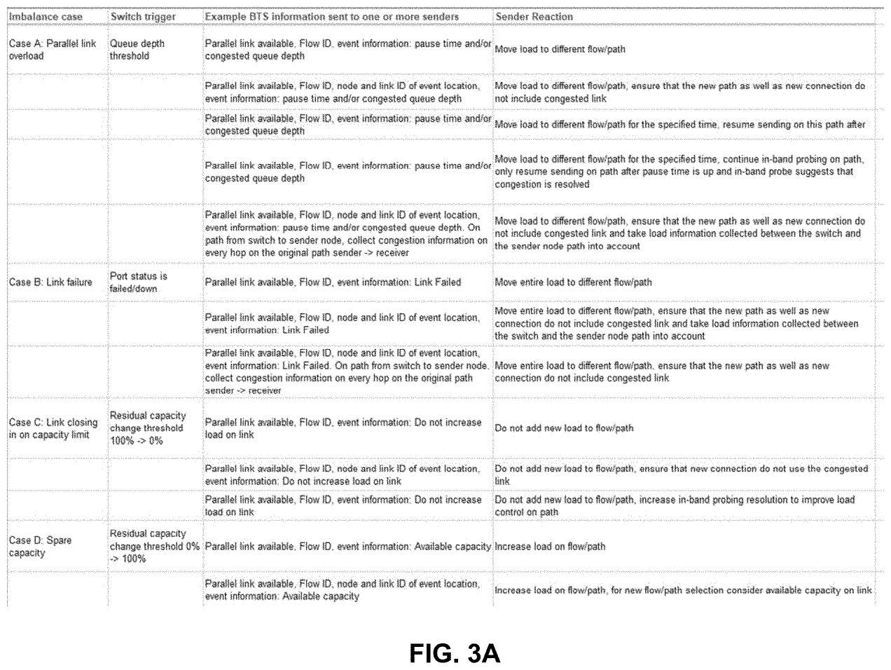

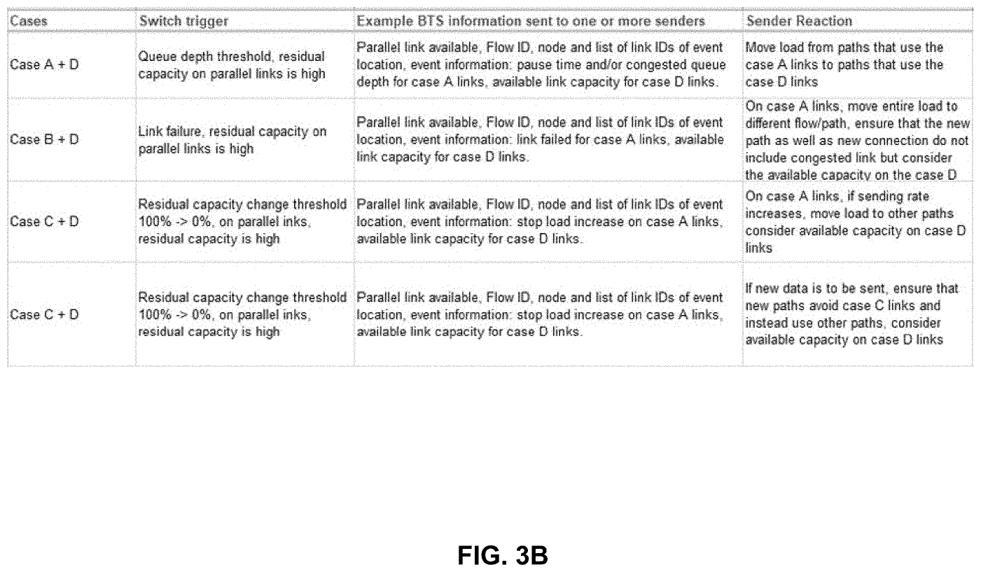

FIGS. 3A and 3B provide examples triggers at congested node (e.g., Switch 1) and sender node reaction to receipt of BTS information. FIG. 3A depicts an example of cases, example switch congestion or link state triggers, example BTS information sent to one or more senders, and example reaction of the one or more senders. For example, for a case A of parallel link overload, a trigger event at a switch can include a queue depth level being met or exceeded. At least for case A and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, event information (e.g., pause time, congested queue depth, and/or queue depth gradient (e.g., an amount or percentage change in queue depth over a time interval)), node and link ID of location of congestion event, or others. BTS information can include congestion information collected on a path from switch to sender node at one or more hops of a path from switch to sender network interface device.

At least for case A and potentially one or more other cases, in response to receipt of the BTS information, the one or more sender network interface devices can perform one or more remedial actions. Remedial actions can include one or more of: move load to different flow or path; select new path(s) as well as new connection(s) that do not include congested link, resume sending on a congested path after congestion clears; allocate packets transmitted on first path or paths to different flow(s)/path(s) for a specified time and resume sending on a first path or paths after the specified time elapses; allocate packets transmitted on first path or paths to different flow(s)/path(s) for a specified time, continue in-band probing on the first path or paths and resume sending on first path or paths after the specified time elapses and in-band probe suggests that congestion is resolved; or allocate packets transmitted on first path or paths to different path or paths as well as new connection or connections that do not include congested link based on load information collected between the switch and the sender node path into account.

For example, for a case B of link failure, a trigger event at a switch can include a port status is failed or down. At least for case B and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, event information (e.g., link failed), node and link ID of location of congestion event, or others. BTS information can include congestion information collected on a path from switch to sender node at one or more hops of a path from switch to sender network interface device. Note that multipath communications can be conducted using ECMP with or without SRD, or other techniques can be used such as segment routing, SPAIN, etc.

At least for case B and potentially one or more other cases, in response to receipt of the BTS information, the one or more sender network interface devices can perform one or more remedial actions. Remedial actions can include one or more of: move load to different flow or path; select new path(s) as well as new connection(s) that do not include congested link; or allocate packets transmitted on first path or paths to different path or paths as well as new connection or connections that do not include congested link based on load information collected between the switch and the sender node path into account.

For example, for a case C of a link reaching or approaching a capacity limit, a trigger event at a switch can include residual capacity is reducing toward 0% or other non-zero value. At least for case C and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, event information (e.g., do not increase load on link), node and link ID of location of congestion event, or others. BTS information can include congestion information collected on a path from switch to sender node at one or more hops of a path from switch to sender network interface device.

At least for case C and potentially one or more other cases, in response to receipt of the BTS information, the one or more sender network interface devices can perform one or more remedial actions. Remedial actions can include one or more of: do not add new load to flow/path, indicate that a new connection does not use the congested link, or increase in-band probing resolution to improve load control on path.

For example, for a case D of spare capacity in a link, a trigger event at a switch can include residual capacity is increasing to 100% or other non-zero value. At least for case D and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, node and link ID of location of congestion event, event information (e.g., available capacity), or others. BTS information can include congestion information collected on a path from switch to sender node at one or more hops of a path from switch to sender network interface device.

At least for case D and potentially one or more other cases, in response to receipt of the BTS information, the one or more sender network interface devices can perform one or more remedial actions. Remedial actions can include one or more of: increase load to flow/path or consider available capacity on link for new flow/path selection.

FIG. 3B depicts an example of various combination cases. For example, for cases A and D, a trigger event at a switch can include reaching queue depth threshold and residual capacity on one or more parallel links is at or above a threshold. At least for cases A and D and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, node and link IDs of location of congestion event, event information (e.g., pause time and/or congested queue depth for case A links or available link capacity for case D links), or others.

At least for cases A and D and potentially one or more other cases, in response to receipt of the BTS information, the one or more sender network interface devices can perform one or more remedial actions. Remedial actions can include moving packet traffic from paths that use the case A links to paths that use the case D links.

For example, for cases B and D, a trigger event at a switch can include link failure and residual capacity on one or more parallel links is at or above a threshold. At least for cases B and D and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, node and link IDs of location of congestion event, event information (e.g., link failed for case B links or available link capacity for case D links), or others.

At least for cases B and D and potentially one or more other cases, in response to receipt of the BTS information, the one or more sender network interface devices can perform one or more remedial actions. Remedial actions can include moving packet traffic from paths that use the case B links (e.g., failed links) to different flow or path where the different flow or path as well as new connection do not include congested link, considering the available capacity on the case D links.

For example, for cases C and D, a trigger event at a switch can include residual capacity on a link decreasing towards 0% but a parallel ink has residual capacity that is at or above a threshold. At least for cases C and D and potentially one or more other cases, the switch can send BTS information to one or more sender network interface devices. For example, BTS information can include one or more of: parallel link available (e.g., one or more other link is available, particular link identifier(s), or indicate a flow hash(es) to select link for ECMP), Flow ID, node and link IDs of location of congestion event, event information (e.g., stop load increase on case C links and available link capacity for case D links), or others.

At least for cases C and D and potentially one or more other cases, in response to receipt of the BTS information, the one or more sender network interface devices can perform one or more remedial actions. Remedial actions can include for case C links, if sending rate increases, move load to one or more other path considering available capacity on case D links or if new data is to be sent, new paths avoid case C links (e.g., link closing in on capacity limit) and instead use other paths, considering available capacity on case D links (e.g., spare capacity).

Note that while examples are described with respect to BTS, information conveyed in BTS can be sent in packet headers, packet payloads, or manners described with respect to High Precision Congestion Control (HPCC) (e.g., “HPCC: High Precision Congestion Control,” SIGCOMM (2019)), or in-network telemetry (INT) (e.g., Internet Engineering Task Force (IETF) draft-kumar-ippm-ifa-01, “Inband Flow Analyzer” (February 2019)) to convey precise link load information.

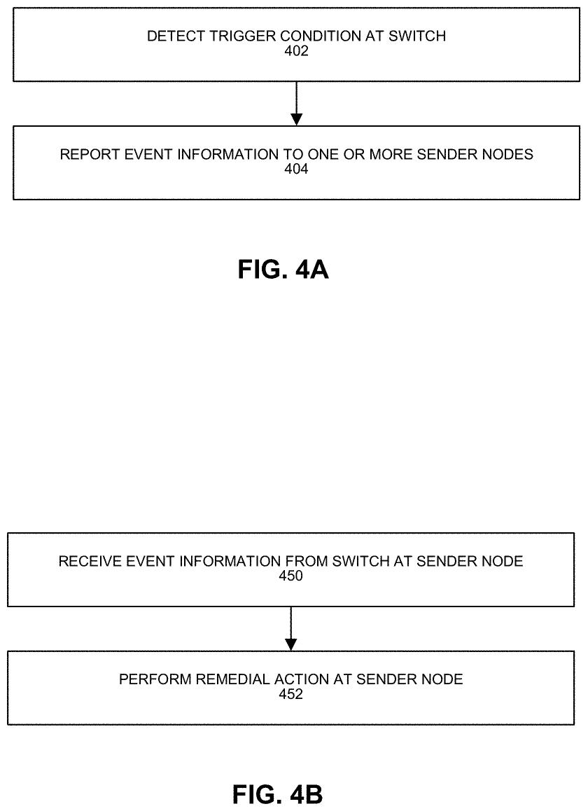

FIG. 4A depicts an example process. The process can be performed by a switch in some examples. At 402, a switch can receive packets for different links for forwarding. In some examples, the different links can be associated with redundant paths for packets from a sender node. At 404, based on a trigger condition, the switch can indicate event information to at least one sender node. The sender node can include a sender of packets using one or more of the different, redundant links. Various examples of trigger conditions include detection of congestion of a queue that stores packets of a link, link failure, failure of a port that transmits packets of a link, capacity of a link increasing, or capacity of a link decreasing to zero or a threshold. Various examples of sender reactions are described herein.

FIG. 4B depicts an example process. The process can be performed by a network interface device in some examples. At 450, the network interface device can receive event information. For example, the event information can be transmitted by a switch based on a trigger condition. The network interface device can transmit packets on a link with one or more backup links available for use. At 452, the network interface device can adjust one or more links used for transmission of packets between a switch that detected and reported the congestion and another switch or another network interface device based on event information. For example, adjusting transmission of packets can include the switch that detected and reported congestion using the congested link and potentially selecting one or more other links to transmit packets. For example, adjusting transmission of packets can include the switch that detected and reported congestion switching from using the congested link to using one or more other links to transmit packets. Various examples of remedial actions are described herein.

FIG. 5 depicts an example network interface device. In some examples, processors 504 and/or FPGAs 540 can be configured to perform path selection for packets based on event information received from a switch, as described herein. Some examples of network interface 500 are part of an Infrastructure Processing Unit (IPU) or data processing unit (DPU) or utilized by an IPU or DPU. An XPU or xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices. In some examples, BTS information can be processed by a processor (e.g., CPU, GPU, accelerator, packet processing pipeline, or others).

Network interface 500 can include transceiver 502, processors 504, transmit queue 506, receive queue 508, memory 510, and bus interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to perform MAC address filtering on received packets, process MAC headers of received packets by verifying data integrity, remove preambles and padding, and provide packet content for processing by higher layers. MAC circuitry 516 can be configured to assemble data to be transmitted into packets, which include destination and source addresses along with network control information and error detection hash values.

Processors 504 can be one or more of: combination of: a processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 504.

Processors 504 can include a programmable processing pipeline that is programmable by Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 504 and/or FPGAs 540 can be configured to perform event detection and action.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit traffic manager can schedule transmission of packets from transmit queue 506. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with or based at least in part on PCI, PCIe, PCI-x, Serial ATA, and/or USB (although other interconnection standards may be used), or proprietary variations thereof.

FIG. 6 depicts an example switch. Various device and processor resources in the switch can be programmed to perform identification of link conditions, event detection, and event indication to a sender node, as described herein. Switch can receive a single packet from the source and sends one copy to one of the recipients. Switch 604 can route packets or frames of any format or in accordance with any specification from any port 602-0 to 602-X to any of ports 606-0 to 606-Y (or vice versa). Any of ports 602-0 to 602-X can be connected to a network of one or more interconnected devices. Similarly, any of ports 606-0 to 606-Y can be connected to a network of one or more interconnected devices.

In some examples, switch fabric 610 can provide routing of packets from one or more ingress ports for processing prior to egress from switch 604. Switch fabric 610 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 608 can be configured to store packets received at ports prior to egress from one or more ports. Packet processing pipelines 612 can determine which port to transfer packets or frames to using a table that maps packet characteristics with an associated output port. Packet processing pipelines 612 can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines 612 can implement access control list (ACL) or packet drops due to queue overflow.

For example, packet processing pipelines 612 can be configured to perform detection of events and indication of events to a sender node, as described herein. Configuration of operation of packet processing pipelines 612, including its data plane, can be programmed using example programming languages and manners described herein. Processors 616 and FPGAs 618 can be utilized for packet processing or modification. In some examples, processors 616 can execute a virtual switch to provide virtual machine-to-virtual machine communications for virtual machines (or containers or other virtual execution environments) in a same server or among different servers.

FIG. 7 depicts an example system. Components of system 700 (e.g., processor 710, graphics 740, accelerators 742, memory 730, storage 784, network interface 750, and so forth) can be utilized to select a path for packets sent by network interface 750 or configure network interface 750 to select a path for transmitted packets. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

In some examples, network interface device 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance. Some examples of network interface 750 are part of an Infrastructure Processing Unit (IPU) or data processing unit (DPU) or utilized by an IPU or DPU. An XPU or xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. A programmable pipeline can be programmed using one or more of: P4, SONiC, C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

In some examples, OS 732 or a driver for network interface device 750 can select a path for packets based on event information of configure network interface 750 to select a path for packets based on event information.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory includes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects or device interfaces can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., Non-Volatile Memory Express (NVMe) Specification, revision 1.3c, published on May 24, 2018 or earlier or later versions, or revisions thereof).

Communications between devices can take place using a network that provides die-to-die communications; chip-to-chip communications; circuit board-to-circuit board communications; and/or package-to-package communications. A die-to-die communications can be consistent with Embedded Multi-Die Interconnect Bridge (EMIB) or utilize an interposer.

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802. Programmable pipeline 804 and/or processors 806 can be configured to perform identification of link conditions and event notification or response to event notification, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writable or re-writable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes a network interface device comprising: circuitry, when operational, to: in response to congestion related to a link, cause transmission of link event information to at least one sender of packets to the link, wherein the link event information is to identify congestion information of at least one link other than the link.

Example 2 includes one or more examples, wherein the congestion related to a link comprises one or more of: link overload of a link that is part of the group of multiple links, link failure of a link that is part of the group of multiple links, link approaching transmission capacity, link in the group of multiple links having spare capacity while another link in the group of multiple links is overloaded, or a combination thereof.

Example 3 includes one or more examples, wherein the link event information comprises one or more of: backup link available, flow identifier, node and link identifier of event location, or event information.

Example 4 includes one or more examples, wherein the link event information comprises one or more of: transmission pause time, congested queue depth, indication of link failure, indication to pause packet transmission rate increase, or indication of available capacity on one or more links.

Example 5 includes one or more examples, wherein the network interface device comprises circuitry that is to determine a link in a group of multiple links to not select for packet transmission in response to receipt of the link event information.

Example 6 includes one or more examples, wherein the network interface device comprises circuitry that, in response to receipt of the link event information, is to perform an action comprising one or more of: select another link in the group of multiple links for packet transmission, select another link in the group of multiple links for packet transmission for a specified time, or select another link in the group of multiple links for packet transmission and revert to packet transmission over a former link.

Example 7 includes one or more examples, and includes a server communicatively coupled to the network interface device, wherein the server is to execute an operating system (OS) to specify an action that the network interface device is to perform in response to the link event information.

Example 8 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 9 includes one or more examples, wherein the circuitry comprises a programmable packet processing pipeline.

Example 10 includes one or more examples, and includes a non-transitory computer-readable medium comprising instructions stored thereon, that if executed by one or more processors, cause the one or more processors to: configure a network interface device to: in response to receipt of link event information, perform at least one action, wherein the link event information comprises congestion information of a link of a switch to which the network interface device transmits packets and congestion information of at least one other link of the switch.

Example 11 includes one or more examples, wherein the link event information is transmitted by at least one switch based on a link state trigger.

Example 12 includes one or more examples, wherein the link state trigger comprises one or more of: link overload of a link that is part of the group of multiple links, link failure of a link that is part of the group of multiple links, link approaching transmission capacity, link in the group of multiple links having spare capacity while another link in the group of multiple links is overloaded, or a combination thereof.

Example 13 includes one or more examples, wherein the link event information comprises one or more of: parallel link available, flow identifier, node and link identifier of event location, or event information, transmission pause time, congested queue depth, indication of link failure, indication to pause packet transmission rate increase, or indication of available capacity on one or more links.

Example 14 includes one or more examples, wherein the at least one action comprises one or more of: determine a link in a group of multiple links to not select for packet transmission, select another link in the group of multiple links for packet transmission, select another link in the group of multiple links for packet transmission for a specified time, or select another link in the group of multiple links for packet transmission and revert to packet transmission over a former link.

Example 15 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 16 includes one or more examples, and includes a method comprising: in a network interface device: adjusting a path of packet transmission among multiple enabled paths based on link event information received from at least one switch, wherein the link event information comprises congestion information of at least two link of the at least one switch.

Example 17 includes one or more examples, wherein the link event information is transmitted from at least one switch based on a link state trigger.

Example 18 includes one or more examples, wherein the link state trigger comprises one or more of: link overload of a link that is part of the group of multiple links, link failure of a link that is part of the group of multiple links, link approaching transmission capacity, link in the group of multiple links having spare capacity while another link in the group of multiple links is overloaded, or a combination thereof.

Example 19 includes one or more examples, wherein the link event information comprises one or more of: parallel link available, flow identifier, node and link identifier of event location, or event information, transmission pause time, congested queue depth, indication of link failure, indication to pause packet transmission rate increase, or indication of available capacity on one or more links.

Example 20 includes one or more examples, wherein the adjusting a path of packet transmission among multiple paths comprises one or more of: determine a link in a group of multiple links to not select for packet transmission, select another link in the group of multiple links for packet transmission, select another link in the group of multiple links for packet transmission for a specified time, or select another link in the group of multiple links for packet transmission and revert to packet transmission over a former link.

What is claimed is:

1. An apparatus comprising:
a network interface device comprising:
circuitry, when operational, to: in response to congestion related to a link, cause transmission of link event information to at least one sender of packets to the link, wherein the link event information is to identify congestion information of at least one link other than the link.

2. The apparatus of claim 1, wherein the congestion related to a link comprises one or more of: link overload of a link that is part of the group of multiple links, link failure of a link that is part of the group of multiple links, link approaching transmission capacity, link in the group of multiple links having spare capacity while another link in the group of multiple links is overloaded, or a combination thereof.

3. The apparatus of claim 1, wherein the link event information comprises one or more of:
backup link available, flow identifier, node and link identifier of event location, or event information.

4. The apparatus of claim 3, wherein the link event information comprises one or more of: transmission pause time, congested queue depth, indication of link failure, indication to pause packet transmission rate increase, or indication of available capacity on one or more links.

5. The apparatus of claim 1, wherein the network interface device comprises circuitry that is to determine a link in a group of multiple links to not select for packet transmission in response to receipt of the link event information.

6. The apparatus of claim 1, wherein the network interface device comprises circuitry that, in response to receipt of the link event information, is to perform an action comprising one or more of: select another link in the group of multiple links for packet transmission, select another link in the group of multiple links for packet transmission for a specified time, or select another link in the group of multiple links for packet transmission and revert to packet transmission over a former link.

7. The apparatus of claim 1, comprising a server communicatively coupled to the network interface device, wherein the server is to execute an operating system (OS) to specify an action that the network interface device is to perform in response to the link event information.

8. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

9. The apparatus of claim 1, wherein the circuitry comprises a programmable packet processing pipeline.

10. A non-transitory computer-readable medium comprising instructions stored thereon, that if executed by one or more processors, cause the one or more processors to:
configure a network interface device to:
in response to receipt of link event information, perform at least one action, wherein the link event information comprises congestion information of a link of a switch to which the network interface device transmits packets and congestion information of at least one other link of the switch.

11. The non-transitory computer-readable medium of claim 10, wherein the link event information is transmitted by at least one switch based on a link state trigger.

12. The non-transitory computer-readable medium of claim 11, wherein the link state trigger comprises one or more of: link overload of a link that is part of the group of multiple links, link failure of a link that is part of the group of multiple links, link approaching transmission capacity, link in the group of multiple links having spare capacity while another link in the group of multiple links is overloaded, or a combination thereof.

13. The non-transitory computer-readable medium of claim 10, wherein the link event information comprises one or more of:
parallel link available, flow identifier, node and link identifier of event location, or event information, transmission pause time, congested queue depth, indication of link failure, indication to pause packet transmission rate increase, or indication of available capacity on one or more links.

14. The non-transitory computer-readable medium of claim 10, wherein the at least one action comprises one or more of: determine a link in a group of multiple links to not select for packet transmission, select another link in the group of multiple links for packet transmission, select another link in the group of multiple links for packet transmission for a specified time, or select another link in the group of multiple links for packet transmission and revert to packet transmission over a former link.

15. The non-transitory computer-readable medium of claim 10, wherein the network interface device comprises one or more of: a network interface controller (NIC), a remote direct memory access (RDMA)-enabled NIC, SmartNlC, router, switch, forwarding element, infrastructure processing unit (IPU), data processing unit (DPU), or network-attached appliance.

16. A method comprising:
in a network interface device:
adjusting a path of packet transmission among multiple enabled paths based on link event information received from at least one switch, wherein the link event information comprises congestion information of at least two link of the at least one switch.

17. The method of claim 16, wherein the link event information is transmitted from at least one switch based on a link state trigger.

18. The method of claim 17, wherein the link state trigger comprises one or more of: link overload of a link that is part of the group of multiple links, link failure of a link that is part of the group of multiple links, link approaching transmission capacity, link in the group of multiple links having spare capacity while another link in the group of multiple links is overloaded, or a combination thereof.

19. The method of claim 17, wherein the link event information comprises one or more of:
parallel link available, flow identifier, node and link identifier of event location, or event information, transmission pause time, congested queue depth, indication of link failure, indication to pause packet transmission rate increase, or indication of available capacity on one or more links.

20. The method of claim 16, wherein the adjusting a path of packet transmission among multiple paths comprises one or more of: determine a link in a group of multiple links to not select for packet transmission, select another link in the group of multiple links for packet transmission, select another link in the group of multiple links for packet transmission for a specified time, or select another link in the group of multiple links for packet transmission and revert to packet transmission over a former link.
